(19) United States
(12) Patent Application Publication
(10) Pub. No.: US 2022/0092996 A1
(43) Pub. Date: Mar. 24, 2022

(54) Apparatus, System and Method for the Self-Loading of a Car in a Carwash

(71) Applicant: Washify Services, LLC, West Roxbury, MA (US)

(72) Inventors: Adam Korngold, Needham, MA (US); Maksym Ukhanov, Kiliya (UA)

(21) Appl. No.: 17/475,497

(22) Filed: Sep. 15, 2021

Related U.S. Application Data
(60) Provisional application No. 63/080,167, filed on Sep. 18, 2020.

(51) Int. Cl. G09B 5/02; B60S 3/00; G06K 9/00; G06T 7/73; G06T 7/12; G06T 7/80; H04N 5/247; G09B 19/16

(52) U.S. Cl. CPC G09B 5/02; B60S 3/004; G06K 9/00624; G06T 7/73; B60S 3/04; G06T 7/80; H04N 5/247; G09B 19/167; G06T 7/12

(57) ABSTRACT

A system is configured to assist a driver in self-loading a vehicle on a car wash conveyor at a loading point located at an entrance to the car wash conveyor. The system includes at least one camera configured to capture a video stream including a plurality of video frames each including images of the loading point, an image processing system configured to map pixel-coordinates in video frames of an ideal loading path of vehicles at the entrance to the car wash conveyor and; and a display configured to display a plurality of dynamic graphical icons on the graphical display to illustrate to the driver a first adjustment required to correct for the error. The system processes images to determine an amount of an error between an actual location of the approaching vehicle and the ideal loading path. The ideal loading path corresponds to a path of the approaching vehicle when properly aligned with the car wash conveyor.

### BACKGROUND OF INVENTION

### 1. Field of Invention

This invention relates generally to carwashes. More specifically, at least one embodiment, relates to an apparatus, system and method for the self-loading of a car in a carwash.

### 2. Discussion of Related Art

Tunnel-style car washes move an automobile through a set of operations that clean an exterior of the car. The operations can include exterior washing, undercarriage washing, drying, an application of wax or sealant and wheel cleaning as some examples. Typically, the car is first placed on a conveyor and then mechanically moved through a fixed path in the tunnel where the equipment that performs the various operations is located. The cleaning operations are performed in a pre-defined sequence as the car is moved adjacent the equipment. The progress of the car through the tunnel is automated and performed independent of the driver, for example, with the car placed in neutral. As a result, a carwash operator is generally not actively involved in the car washing operation once it begins. However, the car must first be properly loaded on the conveyor. Generally, this requires car wash staff to guide the driver to properly align the car and load the car on the conveyor. Properly loading facilitates the proper operation of the conveyor.

In a conventional chain and roller type conveyor system, a track is located such that the front and back tires on one side of the car are secured on the track to move the vehicle through the carwash. The conveyor track includes a tapered entry ramp to assist in guiding the front tire onto the track such that the rear tire on the same side of the vehicle follows onto the track once the track engages the front tire. With proper spacing, vehicles are loaded one after another onto the conveyor such that multiple cars can be on the conveyor at different stages of the overall car wash process. Belt driven conveyors allow the same type of multi-vehicle loading. However, belt driven conveyors allow the front tires on the left side and the right side of the car to be loaded onto belts that are used to move the vehicle through the cleaning stations in the tunnel.

While the entry ramp provides some margin for error it often remains a challenge for drivers to properly align the tires with the conveyor. Misalignment can also easily occur with belt driven conveyor systems, for example, a vehicle can be loaded at an angle such that it is partly diagonal as it is moved into the tunnel. Unless the car wash system performs an emergency shutdown, the misalignment can damage the vehicle and/or the car washing system. Where multiple vehicles are on the conveyor when the emergency shutdown occurs the vehicles are trapped at a stationary location in the tunnel until the system is restarted. Given the problem created by the preceding, otherwise automated tunnel car washing systems continue to require an attendant (i.e., an operator) to assist in guiding drivers when loading their vehicle onto a car wash conveyor.

While cameras have long been used to monitor the operation of tunnel-style car washes, the use has been limited for the loading operation. For example, Chinese patent publication CN 207424636 describes the display of a video to the driver of a vehicle during the loading process. The video shows the position of the vehicle's tire relative the entrance to the conveyor of the vehicle. However, this approach requires a high degree of focus by the driver as they look at the changes in tire position on the video screen in response to any changes in their steering. It is also known to use a camera for vehicle identification or to determine a vehicle location for washing by a movable robot-style arm.

Because an attendant is generally required to guide the driver loading their vehicle onto the conveyor, car wash systems typically do not display any user (i.e., driver) feedback during operation. The most frequent exception is to provide some form of instruction to place the vehicle in neutral once the vehicle is pulled into the proper position by the driver. Where feedback is provided, it is typically in an analog form or an overly simplistic communication using signal lights or perhaps static left-right directional arrows, see for example, U.S. Pat. No. 8,421,650.

### SUMMARY OF INVENTION

Therefore, there is a need for apparatus, systems and methods that monitor a vehicle's location and display user feedback to allow the driver to effectively align and load their vehicle on a car wash conveyor without the aid of an attendant. According to various embodiments, a fully automated loading process results to allow the driver to self-load their vehicle without aid of car wash personnel. According to some embodiments, dynamic graphical icons are employed to readily convey information concerning an adjustment a driver must make to align their vehicle for loading. In one embodiment, the dynamic graphical icons display non-numeric symbols to convey a magnitude of the adjustment. That is, the dynamic graphical icons can be rendered in a manner that conveys a scale or amount of adjustment needed.

According to one aspect, a method is provided to assist a driver self-loading a vehicle on a car wash conveyor using feedback concerning a location of the vehicle relative to an ideal loading path. The feedback is displayed to the driver using a graphical display located such that it is visible to the driver while in the vehicle approaching a loading point for the car wash conveyor. According to some embodiments, the method includes mapping an ideal loading path of a vehicle at an entrance to the car wash, the ideal loading path corresponding to a path of a vehicle that is properly aligned on its approach to load the vehicle onto the car wash conveyor and evaluating images included in at least one video stream of the entrance to determine whether a vehicle is approaching a loading point for the car wash conveyor. According to one embodiment, the vehicle is identified, images included in the at least one video stream are evaluated to determine an amount of an error between an actual location of the vehicle and the ideal loading path where the error is determined as a lateral alignment of the vehicle relative to the ideal loading path. Images included in the at least one video stream are evaluated to determine a forward distance the vehicle must travel to reach the loading point and a plurality of dynamic graphical icons are displayed on the graphical display to illustrate to the driver a first adjustment required to correct for the error and a second adjustment required to drive the vehicle forward to reach the loading point.

According to another aspect, a non-transitory computer-readable medium is provided where the non-transitory computer-readable medium includes computer program instructions executable by at least one computer processor to perform a method to assist a driver self-loading a vehicle on a car wash conveyor using feedback concerning a location of the vehicle relative to an ideal loading path. The feedback is displayed to the driver using a graphical display located such that it is visible to the driver while in the vehicle approaching a loading point for the car wash conveyor. According to some embodiments, the method includes mapping an ideal loading path of a vehicle at an entrance to the car wash, the ideal loading path corresponding to a path of a vehicle that is properly aligned on its approach to load onto the car wash conveyor and evaluating images included in at least one video stream of the entrance to determine whether a vehicle is approaching a loading point for the car wash conveyor. According to one embodiment, the vehicle is identified, images included in the at least one video stream are evaluated to determine an amount of an error between an actual location of the vehicle and the ideal loading path where the error is determined as a lateral alignment of the vehicle relative to the ideal loading path. Images included in the at least one video stream are evaluated to determine a forward distance the vehicle must travel to reach the loading point and a plurality of dynamic graphical icons are displayed on the graphical display to illustrate to the driver a first adjustment required to correct for the error and a second adjustment required to drive the vehicle forward to reach the loading point.

As used herein, the term “dynamic graphical icon” refers to a graphics element rendered in a display that can operate to change characteristics in a manner that conveys information to a viewer of the icon. For example, depending on the embodiment, the dynamic graphical icon can vary in size, shape, color, location within a display or any combination of the preceding. These changes to the dynamical graphical icon include a temporal element because the changes occur over time while the dynamic graphical icon is viewed by the viewer. Depending on the changes being represented by the dynamic graphical icon and the circumstances, a change in characteristics can range from those that appear as rapid changes to those that appear as gradual changes. One of ordinary skill in the art will recognize in view of the disclosure provided herein that an icon found on a desktop of a PC or the home screen of a mobile phone (typically representative of a software application) are not dynamic graphical icons because they have a static appearance and location in the graphical user interface.

As used herein, the term “loading point” refers to a location on either a chain and roller conveyor or a belt driven conveyor at which the vehicle that is being loaded must be located before the conveyor is started. While referred to as “point” those of ordinary skill in the art will understand based on the disclosure provided herein that the loading point includes a region that allows for a limited amount of variance in an at rest position of the vehicle before the conveyor is started.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a self-loading car wash system in accordance with one embodiment;

FIG. 2A illustrates a plan view of a self-loading car wash system in accordance with an embodiment employed with a chain and roller conveyor system;

FIG. 2B illustrates a front view of a display unit according to the embodiment illustrated in FIG. 2A;

FIG. 3A illustrates a plan view of a self-loading car wash system in accordance with an embodiment employed with a belt driven conveyor system;

FIG. 3B illustrates a front view of a display unit according to the embodiment illustrated in FIG. 3A;

FIGS. 4A and 4B illustrate images employed in a self-loading car wash system in accordance with one embodiment;

FIGS. 5A and 5B illustrate images employed in a self-loading car wash system in accordance with a further embodiment;

FIG. 6 illustrates a flow diagram of a process in accordance with one embodiment; and

FIGS. 7A-7C illustrate a graphical display in accordance with one embodiment.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

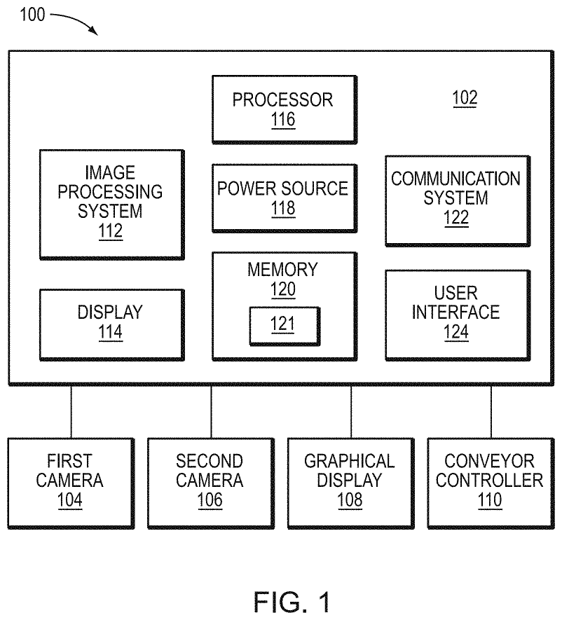

Referring to FIG. 1, a self-loading car wash system 100 is illustrated in accordance with one embodiment. According to the illustrated embodiment, the system 100 includes a control unit 102, a first camera 104, a second camera 106, a graphical display 108 and a conveyor controller 110. The control unit 102 includes an image processing system 112, a display 114, a processor 116, a power source 118, a memory 120, a communication system 122 and a user interface 124. The self-loading car wash system 100 operates to capture images of a loading area of a car wash with the cameras 104, 106, process the images using the control unit 102, graphically display instructions to drivers via the graphical display 108 and control the car wash conveyor to start the conveyor when a vehicle is properly aligned with the conveyor as determined as a result of the image processing.

In general, the control unit 102 allows a car wash operator and/or a system administrator who can be either local or remote from the site of the car wash to monitor and control an operation of the self-loading car wash system 100. According to some embodiments, the control unit 102 is processing device such as a personal computer. Depending on the embodiment, the control unit can include a desktop computer, a laptop computer or a portable electronic device such as a tablet computer, a hand-held computer or a combination of any two or more of the preceding processing devices and/or other processing devices. Further, the control unit 102 can include cloud-based resources hosted on remote servers accessed over the Internet. Each of the preceding embodiments may be employed provided that the image processing and driver feedback is provided rapidly enough to allow the driver to make corrections without having to back the vehicle up. In some embodiments, the image processing and associated feedback provided to the driver (for example, via display of dynamic graphical icons) is provided in near real-time, i.e., with a delay of approximately one second. In another embodiment, the image processing and associated feedback is provided to the driver in substantially real time, i.e., with no discernible delay.

The image processing system 112 can include one or more algorithms that evaluate a series of images provided by one or more video streams to determine: a) whether a vehicle is approaching a loading point for the car wash conveyor; b) an amount of error between an actual location of the vehicle and a loading path that properly aligns vehicles for loading; and c) a forward distance the vehicle must travel to reach the loading point from its current location. According to some embodiments, the image processing system 112 employs edge detection to identify vehicles in a video stream and determine a respective centroid for each of the vehicles. The image processing system 112 tracks the loading path of the centroid of each vehicle for comparison with the loading path of a centroid corresponding to a vehicle that is properly aligned with the car wash conveyor system. With this information, the image processing system 112 determines a direction and magnitude of any misalignment between the loading path of a vehicle that is being loaded on the conveyor and the ideal loading path for loading.

Depending on the embodiment, the image processing system 112 can be implemented in software, hardware or firmware or any combination thereof. Accordingly, any of the embodiments described herein can provide the image processing algorithms included in the system 112 in the form of a non-transitory computer readable medium in which instructions are stored that when executed by a processing system implement the image processing described herein. Depending on the embodiment, the image processing system 112 can be executed by a central processing unit such as the processor 116 and/or a more specialized processor such as a graphics processing unit (GPU). Further, aspects of the image processing system 112 can be implemented with a specially-programmed, special purpose hardware, for example, an application-specific integrated circuit (ASIC).

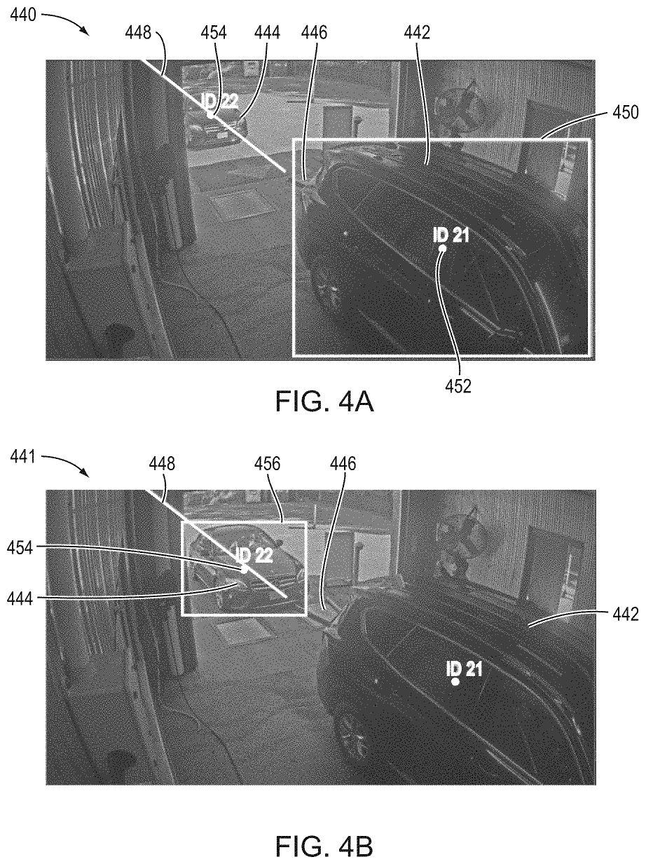

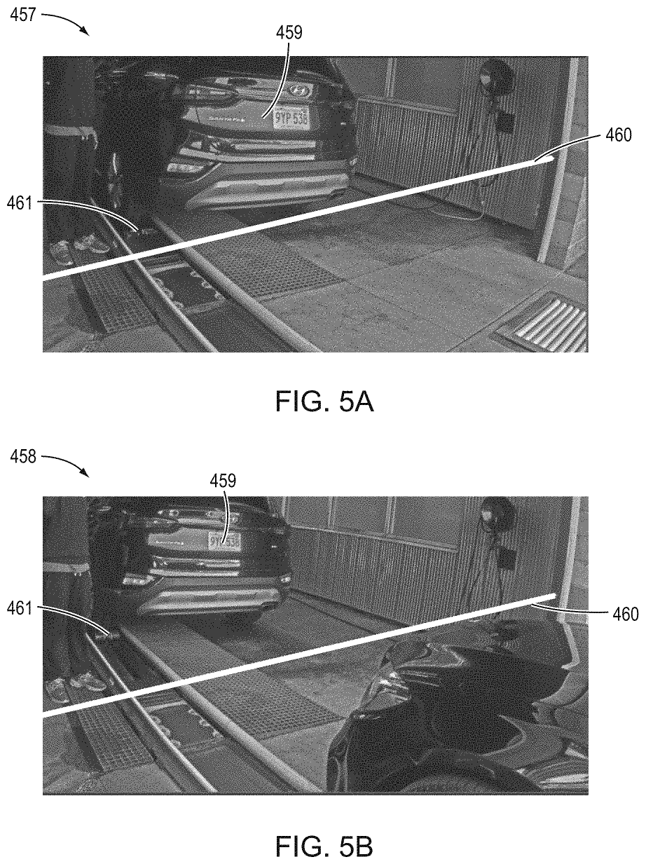

The display 114 provides an operator of the control unit 102 with the display of information that is employed to review the video streams and results of image processing in real time as described in greater detail with reference of FIGS. 4A-5B. The display can include a display of the loading area of the car wash as well as other sections of the complete conveyor system. Depending on the embodiment the display 114 can include an LCD monitor, an LED monitor or other display technology including a touch screen display.

The processor 116 provides a central processing unit for the control unit 102. The processor can perform operations that include image processing. Further, the processor 116 can include a single processor, multiple processors and specialized processors such as a GPU depending on the embodiment. In general, the processor 116 operates to control the overall operation of the control unit 102, for example, the operation of the hardware elements included in the control unit, reading and writing information to the memory and execution of software instructions by the control unit 102.

The power source 118 can include a converter for converting AC power to DC power for operation of the elements of the control unit 102. Accordingly, the recharging circuitry can include a wired electrical connection available from an exterior of the control unit 102. In some embodiments (for example, where the control unit 102 includes a laptop computer), the power source 118 includes one or more batteries, for example, lithium or alkaline batteries integral to the control unit 102. In these embodiments, the power source 118 can include a replaceable power source or a rechargeable power source. Where a rechargeable power source is employed, the power source 118 can include recharging circuitry to regulate charging operations.

The memory 120 is configured to store software instructions 121 in accordance with various embodiments. The software instructions can include one or more algorithms or other programs, for example, algorithms for determining whether a vehicle is approaching the loading point, determining any error in a vehicle's approach to the loading point, determining a forward progress of a vehicle relative to the loading point and controlling the generation and display of dynamic graphical icons used to provide instructions to the operator of a vehicle approaching the loading zone. In one embodiment, the memory 120 is included in the processor 116. In another embodiment, the memory 120 includes memory internal to the processor 116 and memory external to the processor 116.

Depending on the embodiment, the communication system 122 can include wired or wireless communication. The communication system 122 can communicate via either or both of local-area networks (LANs), wide area networks (WANs), wireless communication, wired communication and may include the Internet. According to a further embodiment, the communication system 122 provides access “over-the-cloud” to one or more remote resources such as servers, applications and/or data storage systems. Communication can occur using any of Wi-Fi networks, BLUETOOTH communication, cellular networks and satellite communication. Other communication protocols and topologies can also be implemented in accordance with various embodiments. The communication system 122 can be included as a standalone element or included in the processor 116 depending on the embodiment.

The user interface 124 can include any one of or any combination of a keyboard, a mouse, a joy stick, voice recognition and the display 114 (for example, a graphical user interface rendered in the display). According to some embodiments, the user interface includes speakers to provide audio notifications or alerts. In general, the user interface 124 allows a car wash operator and/or a system administrator (whether local or remote) to monitor and control an operation of the self-loading car wash system 100.

In various embodiments, the control unit 102 can monitor and control an operation of the first camera 104, the second camera 106, the graphical display 108 and the conveyor controller 110. The communication between the control unit 102 and the preceding system elements can include a communication of any of analog signals, digital signals, video signals, audio signals and graphics data.

According to one embodiment, each of the first camera 104 and the second camera 106 are installed in the vicinity of the loading area which can include the loading point (i.e., the point at which the vehicle is located at the correct position to start the conveyor) and the approach to the loading point (i.e., the area immediately adjacent the loading point through which a vehicle travels as it is steered by the driver toward the conveyor). In some embodiments, two cameras are employed to allow a first of the two cameras (for example, the first camera 104) to record video of the approach while a second of the two cameras (for example, the second camera 106) is focused on the loading point and pointed in a direction facing into the car wash tunnel. According to these embodiments, the video signal provided by the first camera 104 is processed by the control unit 102 to determine a lateral alignment of the vehicle on approach to the loading point. In these embodiments, the video signal provided by the second camera 106 is processed by the control unit 102 to determine how much further the vehicle must travel to reach the loading point. According to other embodiments, three or more cameras are employed, for example, to add to any of the functionality, the precision and/or the speed of operation of the system 100. The cameras can provide conventional video or HD video depending on the embodiment. In various embodiments, the cameras are configured to decrease the stream delay and optimize performance. In a preferred embodiment, the cameras 104, 106 are color HD cameras with a fame-rate of at least fifteen frames per second. According to one embodiment, an IP camera from Axis Communications is employed.

The graphical display unit 108 is located in the loading area within the line of sight of a driver of a vehicle as the vehicle approaches the loading point. In general, the operation of graphical display unit 108 provides a set of dynamic graphical icons that convey instructions to the driver of the vehicle to guide them through the self-loading of their vehicle on the car wash conveyor. The graphical display unit 108 can communicate other information to the driver, for example, a graphic including text and/or images that identifies the type of car wash service that the driver has requested, an amount paid for the service and text instructions concerning the self-loading operation. According to some embodiments, the graphical display unit 108 is included in a console or cabinet that includes other hardware, for example, a speaker to provide audio information to the driver, a microphone to allow the driver to communicate with car wash staff, video hardware including a video monitor and/or a camera and control systems employed to control an operation of the conveyor. According to one embodiment, one or more functions and/or elements described with reference to the control unit 102 are included in the console with the graphical display unit 108.

In general, the conveyor controller 110 includes an electromechanical device that operates to start and stop the car wash conveyor. According to one embodiment, the conveyor controller includes a relay that operates to engage rollers to start the car wash conveyor when a vehicle reaches the loading point.

While the description concerning the self-loading car wash system 100 is described with a control unit 102 that is remote from the graphical display 108, all or a portion of the control unit 102 can be installed at the same location (for example, in a single enclosure). For example, a separate standalone control unit 102 may not be employed. Instead, a system including the image processing system 112, the processor 116, the power source 118, the memory 120 and the communication system 124 can be included with the graphical display 108 as one control and display unit in a single enclosure. According to this embodiment, each of the display 114 and the user interface 124 may optionally be included in the system. Further, these embodiments, can allow an operator, developer or system administrator to remotely access the system 100, for example, via a LAN, wireless communication system and/or the Internet.

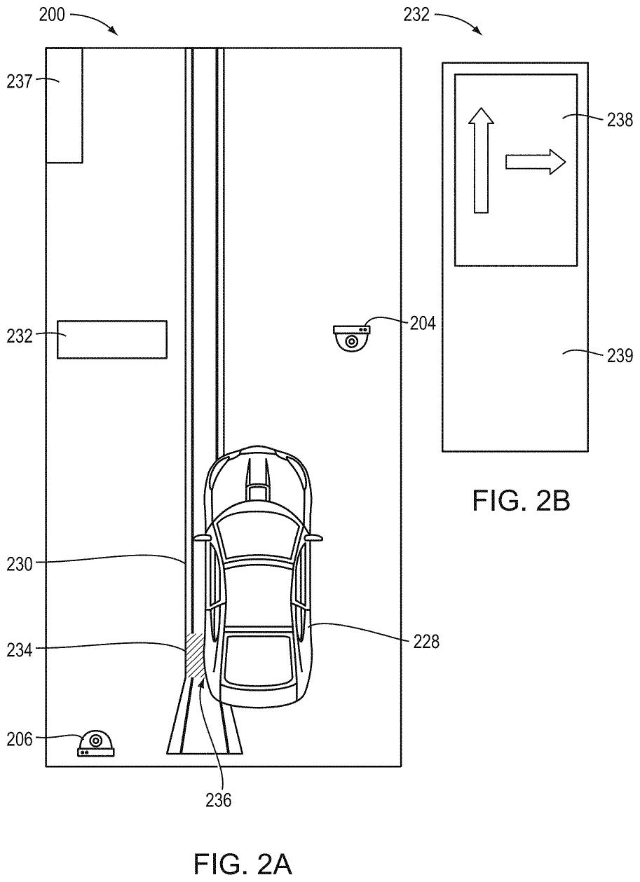

FIGS. 2A/B and 3A/B illustrate views of a self-loading car wash system installed with a chain and roller type conveyor system and a belt driven conveyor, respectively. Referring to FIG. 2A, a self-loading car wash system 200 for a chain and roller conveyor is illustrated. A vehicle 228 is also included in FIG. 2A. According to the illustrated embodiment, the car wash system 200 includes a chain and roller conveyor 230, a first camera 204, a second camera 206, a display unit 232, a roller line 234, a loading point 236, and a relay 237.

According to the illustrated embodiment, the vehicle 228 is located at the loading point 236. The first camera 204 located forward of the vehicle captures video of the vehicle's approach to the loading point 236 to determine whether the vehicle 228 is properly aligned with the chain and roller conveyor 230. That is, the video feed from the first camera 204 is processed to determine whether the vehicle 228 should be steered straight ahead and/or left or right to properly align the vehicle 228 with the chain and roller conveyor 230. A second camera 206 located rear of the vehicle 228 captures video of the loading point 236 to determine whether the vehicle 228 is located far enough forward to reach the loading point 236. Generally, the driver places the vehicle 228 in neutral when the loading point 236 is reached. The video stream captured by the second camera 206 can also be processed to determine whether the driver is stepping on the brake. For example, to avoid having the vehicle 228 to jump off the conveyor during operation, it is important to monitor the status of the vehicle's brakes.

Referring now to FIG. 2B, the display unit 232 includes a display 238 housed in a stand 239. According to the embodiment illustrated in FIG. 2A, the display unit 232 is located on the driver's side of the vehicle 228 and the conveyor 230. Depending on the embodiment, the display unit 232 can be located at any location in the loading area provided that it is within line-of-sight of the driver of the vehicle 228 on approach to the loading point 236. For example, the display unit 232 can be located in a display overhead the conveyor 230 and facing the driver as they pull forward to the loading point 236.

The relay 237 is also located in the vicinity of the chain and roller conveyor 230. The relay 237 can provide an electronic, electrical or electromechanical operation to signal an operation of the roller and the start of the conveyor 230. For example, where an electromechanical relay is used, an electrical signal energizes a coil included in the relay when the vehicle 228 reaches the loading point 236. The relay 237 operates to change the state of electrical contacts to supply power to an operator for the mechanical rollers. The mechanical roller activates to rise up and engage the back of a rear tire such that the car is moved forward with the operation of the conveyor 230. According to some embodiments, the relay 237 can also operate to stop the conveyor 230, for example, during either normal operation when the vehicle 228 exits the conveyor 230 or on an emergency basis if there is a problem in the operation. In general, the relay 237 can provide logic to communicate a wide variety of commands to the car wash system. For example, the relay 237 can output signals that provide information for the type of car wash selected by the driver of a particular vehicle.

Various elements of the system 100 illustrated in FIG. 1 are included in the self-loading car wash system 200 of FIGS. 2A/B, for example, the first camera 204 and the second camera 206. In a further embodiment, the conveyor controller 110 can include the relay 237. Further, the display unit 232 includes the graphical display 108. Depending on the embodiment, one or more elements included in the control unit 102 are located in the display unit 232. For example, in one embodiment, all or a portion of the image processing system 112 can be included in the control unit 102. In these embodiments, the display unit 232 can also include a processor, power source, memory, communication system and user interface used in combination with similar separate elements included in the control unit 102. According to one embodiment, the complete control unit 102 is included in the display unit 232.

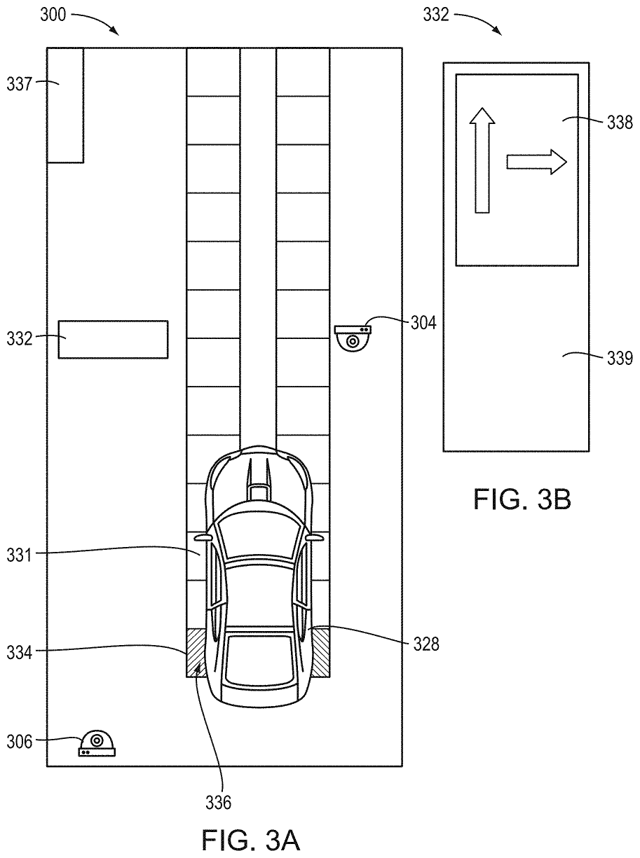

FIG. 3A illustrates a self-loading car wash system 300 for a belt driven conveyor 331. A vehicle 328 is also included in FIG. 3A. The belt driven conveyor in FIG. 3 includes two tracks, a left track and a right track that travel in parallel, together. A first camera 304, a second camera 306, a display unit 332 and a relay 337 are employed in the system 300 in the manner described with reference to the system 200 of FIG. 2A. In operation, the vehicle 328 is pulled forward onto the belt driven conveyor 331 until the rear tires of the vehicle 328 reach the loading point 336. The display unit 332 provides feedback and instructions to the driver to guide them in properly positioning the vehicle 328 at the loading point 336. When the loading point 336 is reached, a signal is provided to the relay 337 to start an operation of the belt driven conveyor 331 and move the vehicle 328 into the car wash.

Referring now to FIG. 3B, the display unit 332 includes a display 338 housed in a stand 339. Various elements of the control unit 102 can be included in the display unit 332 as described above with reference to the display unit 232 illustrated and described with reference to FIGS. 2A/B. For example, the display unit 332 can also include the image processing system 112 and control unit 102 including a processor, power source, memory, communication system and user interface used in combination with similar separate elements included in the control unit 102.

The video frames illustrated and described with reference to FIGS. 4A & 4B are provided to aid in the description of the image processing that is employed by the self-loading car wash system 100, 200, 300. The video stream is generally not visible to drivers and is instead processed during system operation. The video stream can also be viewed by system developers, operators and administrators with proper access to the system 100, 200, 300. Referring now to FIG. 4A, a video frame 440 is illustrated in accordance with one embodiment. The image provide by the video frame 440 includes a first vehicle 442, a second vehicle 444 and a loading ramp 446 for a chain and roller type conveyor system. Graphic elements included in the video frame 440 include a loading-path reference 448, a centroid associated with the first vehicle 450, a central-location reference for the first vehicle 452 and a central-location reference for the second vehicle 454. The central-location reference for the first vehicle 452 includes an associated vehicle ID 21. The central-location reference for the second vehicle 454 includes an associated vehicle ID 22. Depending on the embodiment, the information provided by the graphics elements such as the loading path reference 448, centroid 450, and central-location references 452, 454 is employed by the image processing system 112 but is not necessarily rendered in the video stream. That is, while the generation of a centroid and corresponding central location is employed by the image processing system the information provided by these features can be processed without rendering them for display. For example, according to some embodiments, a centroid is generated for each of the vehicles located in the video frame.

In general, FIGS. 4A and 4B illustrate image processing employed to detect the lateral alignment of a vehicle approaching the loading ramp 446. That is, whether an approaching vehicle should be driven straight ahead, steered to the left or steered to the right to properly align the vehicle for loading on the conveyor. According to some embodiments, the video stream is provided from the first camera 104.

The overall image processing operation includes an identification of an ideal loading path in the video frame. The ideal loading path is the loading path that properly aligns an approaching vehicle with the loading ramp 446. According to the embodiment illustrated in FIGS. 4A and 4B, the loading-path reference 448 illustrates the ideal loading path. The location of the loading-path reference 448 is known by the image processing system at a pixel coordinate level in the video frame 440. The centroid that is established for each vehicle entering the car wash is the location of the respective vehicle as determined by the image processing system. The boundary defined by the centroid corresponds to the edges of the vehicle in the video frame. That is, an object defined by a group of pixels is identified as a vehicle. The pixels that provide the outer edge at the top, bottom, left and right of the object are identified and the centroid is formed using this information. According to various embodiments, the image processing system scans the full video frame to detect any vehicles located in the frame. The quantity of vehicles that may appear in a video frame will in part depend on the field of view of the camera. Therefore, some frames will include more than two vehicles. In some embodiments, edge detection is employed by the image processing system 112 to identify each vehicle located in the video frame.

The central-location reference is determined by the image processing system as the center of the centroid associated with each vehicle, respectively. A location of the central-location reference is also known the image processing system at the pixel-coordinate level. The location of the centroid moves forward with the vehicle as the vehicle approaches the loading ramp 446. As a result, the central-location reference also moves forward. As the vehicle moves forward, the image processing system tracks the central-location reference and compares that location against the loading-path reference 448. Where a difference exists, the system operates to display instructions to the vehicle operator to indicate the direction that the vehicle must be steered to properly align the vehicle with the loading ramp.

In FIG. 4A, the first vehicle 442 has already been successfully driven onto the loading ramp 446 and is now located on the conveyor. Consequently, the loading-path reference 448 is no longer used as a reference for the first vehicle 442. This is evidenced by the location of the central-location reference for the first vehicle 452 now located forward of the loading-path reference 448.

With the first vehicle 442 properly aligned on the conveyor, the image processing system transitions to process image data concerning a location of the second vehicle 444 relative to the loading-path reference 448. In general, the image processing system operates to track a position of the vehicle closest to the loading point that has not passed the required position checks while also displaying instructions for the driver of that vehicle on the graphical display 108.

Referring now to FIG. 4B, a video frame 441 captured subsequent to the video frame 440 includes a centroid associated with the second vehicle 456 as it nears the loading ramp 446. The video frame 441 includes the central-location reference for the second vehicle 454. The image processing system 112 operates to determine any error between a location of the central-location reference for the second vehicle 454 and the loading-path reference 448. The system 100, 200, 300 provides continuous graphics-based instructions to the driver to illustrate an amount of any adjustment in steering, if any, that is required of the driver to properly align the vehicle 444 with the loading ramp 446.

In various embodiments, the system 100, 200, 300 also determines the forward progress of the vehicle onto the conveyor as a second type of position check. Referring now to FIGS. 5A and 5B, image processing employed to detect a forward progress of a vehicle on the conveyor relative to the loading point is illustrated. This view is used to determine whether an approaching vehicle has traveled forward on the conveyor to a point where the rear tires are properly located to turn the conveyor on. This view is also used to determine whether the brake lights of the vehicle are off. According to some embodiments, the video stream that includes the video frames illustrated in FIGS. 5A and 5B is provided from the second camera 106.

FIGS. 5A and 5B illustrate video frames 457 and 458, respectively. Each of the video frames 457 and 458 includes a vehicle 459 where the video frame 458 is captured subsequent in time to the video frame 457. Each of the video frames 457, 459 also include a loading reference-line 460 and a roller 461. The roller 461 is included in the chain and roller conveyor system, for example as illustrated in FIG. 2A. The loading reference-line 460 is a graphics elements rendered in the video frames 457, 458 to provide a visual reference. However, in practice it is not necessary to render the loading reference-line 460 in the video stream for the image processing system to operate as described here. The loading reference-line 460 corresponds to a point the rearmost part of the vehicle 459 must reach to begin operation of the conveyor to move the vehicle into the car wash. The image processing system is calibrated such that the set of pixels that define the line are oriented based on the orientation of the camera relative to the location of the track of the chain and roller track in the video frames. Consequently, the loading reference-line is located at an angle other than a right angle relative to the edges of the video frame.

Referring to FIG. 5A, the vehicle 459 is pulled forward on the conveyor such that the rear bumper is just beyond the loading reference-line 460. This location is referred to as the loading point because it corresponds to a location that places the vehicle 459 in the position for the conveyor to begin operation. That is, the vehicle is not ready for engagement with the roller 461 and activation of the conveyor until it is pulled just forward of the roller 461. The image processing system 112 operates to monitor the progress of the vehicle relative to the loading point and communicates instructions to the driver based on the vehicle's progress. For example, the graphical display 108 can provide one or a plurality of dynamic graphical icons in the display 108 to illustrate the progress of the vehicle to the driver. The display 108 can then provide a stop indication to the driver when the loading point is reached. The display 108 can also provide other instructions, for example, text instructions such as “Place the Vehicle in Neutral” and/or “Keep Your Foot Off the Brake.”

FIG. 5B illustrates the video frame 458 where the vehicle 459 has reached the loading point. At this point, the vehicle 459 is stopped and the chain and roller conveyor begins operation. According to the illustrated embodiment, the roller 461 is raised up behind the rear tire of the vehicle 459. For example, the control unit 102 provides an operating signal to the conveyor controller (the relay in the embodiment illustrated in FIGS. 2 and 3). According to one embodiment, the loading point allows for approximately one foot of variance (i.e., tolerance) in the vehicle's location where it is considered to be pulled forward to the proper location.

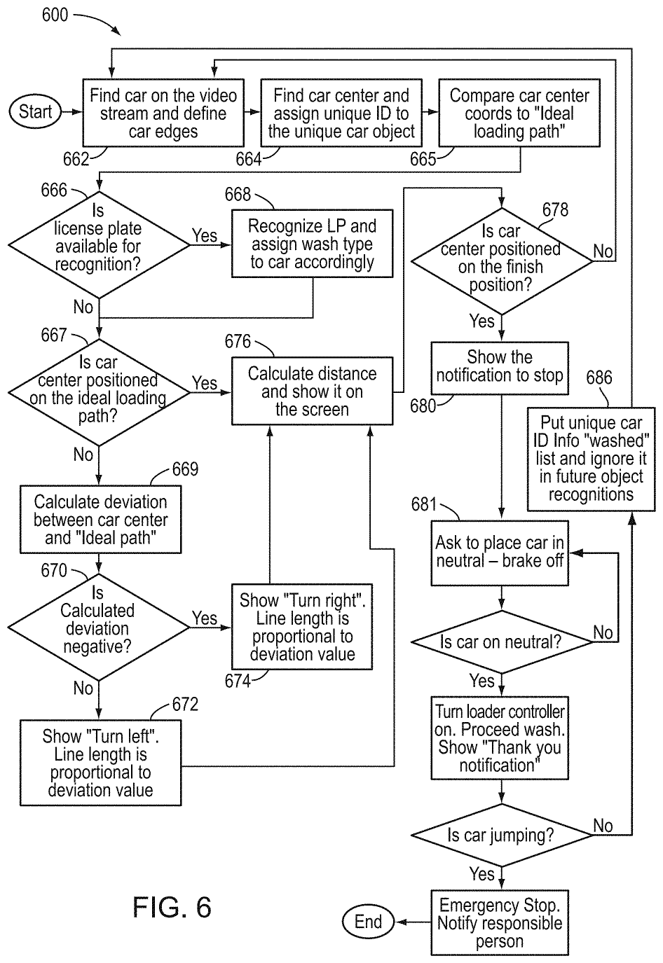

Referring now to FIG. 6, a flow diagram of a process 600 employed in a system for self-loading a vehicle on a car wash conveyor is illustrated in accordance with one embodiment. According to some embodiments, the process 600 employs the self-loading car wash system 100 to evaluate the video streams that include the loading area of the car wash. In these embodiments, the system operates to process the video streams and provide information displayed to the driver to instruct them on the steering required to properly load their vehicle on the conveyor.

The process 600 begins with an act of locating vehicles on the video stream and defining the edges of the vehicles in the images in the video stream 662. The act 662 and others of the acts included in the process 600 are directed to determining whether the vehicle has reached the loading point. As a result, these acts are rapidly repeated, in one embodiment, at a rate of 25 times per second. According to one embodiment, the act 662 includes the act of grabbing the next frame from the video stream to identify any vehicles in the frame and to define the edges of those vehicles. From the act 662, the process moves to the act of finding a center for any of the vehicles identified in the video stream and assigning a unique ID to each vehicle, respectively 664. With the vehicles identified, an act of comparing pixel coordinates of the center of the vehicle-object to the coordinates of the ideal loading path 665 is performed. The process next performs an act of determining whether the license plate on the vehicle is available for recognition in the video stream 666. If the license plate is unavailable, the process moves to an act of determining whether the center of the vehicle is positioned on the ideal loading path 667. However, if the license plate is available for recognition, the process moves to the act of recognizing the license plate and assigning a wash type to the vehicle 668 before proceeding to the act of determining whether the center of the vehicle is positioned on the ideal loading path 667.

The act of determining whether the center of the vehicle is positioned on the ideal loading path 667 continues for the vehicle closest to the loading ramp until the vehicle successfully reaches the loading point. During this time, if the vehicle center is not positioned on the ideal loading path, the process 600 moves to an act of calculating a deviation between the center of the vehicle and the ideal loading path 669. To provide the driver with assistance, the process 600 determines both the magnitude and direction of any deviation/error. The process moves to an act of determining whether the calculated value is a negative value 670. If the calculated value is positive rather than negative, the process moves to an act of adjusting the graphical display to display a symbol pointing in a left direction with a length that is proportional to the magnitude of the deviation 672. If the calculated value is negative, the process moves to an act of adjusting the graphical display to display a symbol pointing in a right direction with a length that is proportional to the magnitude of the deviation 674. That is, a dynamic graphical icon is displayed in a manner that indicates both the direction and the amount of adjustment that is required. According to some embodiments, the preceding is accomplished without the need to display any text or numerical information. Following each of the acts 672, 674, the process moves to an act of calculating a distance the vehicle is from the loading point 676 and adjusting the graphical display to display a symbol representative of a magnitude of the distance to the loading point 676. The process 600 evaluates the position of the center of the vehicle at an act of determining whether the vehicle has reached the loading point 678. If the vehicle has not reached the loading point, the process returns to the act of locating vehicles on the video stream and defining the edges of the vehicles in the images in the video stream 662.

If it is determined that the vehicle has reached the loading point at the act 678, the process moves to an act of updating the graphical display to display a stop notification to the driver 680. Following an act of displaying a stop notification 680, the process 600 moves to an act of updating the graphical display to display notifications to place the vehicle in neutral and keep off the brake 681. The process 600 includes an act of monitoring whether the vehicle is in neutral 682. If the vehicle is not in neutral, the process 600 returns to the act of displaying a notification to place the vehicle in neutral and keep off the brake 681. If the vehicle is in neutral, the process 600 moves to an act of activating the conveyor to engage the vehicle with the conveyor and begin the washing operation 683. According to the illustrated embodiment, the act 683 also includes updating the graphical display to display a notification that thanks the driver.

The process 600 monitors whether the vehicle is secure in the conveyor track at an act of determining whether the vehicle has jumped the conveyor track 684. The car washing operation for the vehicle continues and the process moves to an act of entering the unique vehicle ID into a “washed” list 686 if the system determines that the vehicle has not jumped the conveyor track at the act 684. According to the illustrated embodiment, the act 684 also includes ignoring the vehicle where it appears in future video frames because the vehicle is successfully located on the conveyor. The process 600 continues by returning to the act of locating vehicles on the video stream and defining the edges of the vehicles in the images in the video stream 662. The process 600 then proceeds with the preceding steps for the vehicle that is closest to the loading point of the conveyor. However, if the preceding vehicle is identified as having jumped the track at the act of determining whether the vehicle has jumped the conveyor track 684, the process 600 moves to an act of implementing an emergency shutdown of the conveyor. According to the illustrated embodiment, the act 684 also includes providing a notification to an individual responsible for operation of the car wash.

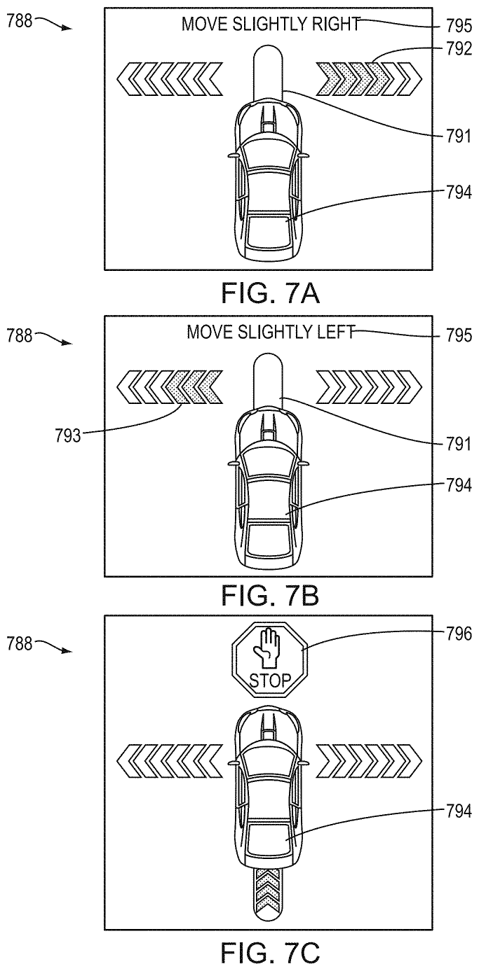

Embodiments of the various self-loading car wash systems 100, 200, 300 described herein employ dynamic graphical icons to communicate information to assist a driver in guiding their vehicle to the loading point on the car wash conveyor system. FIGS. 7A-7C provide various examples of dynamic graphical icons included in a graphics display 788. Depending on the embodiment, the graphics display 788 can be included in the graphical display 108 or the display unit illustrated and described with reference to FIGS. 2A/B and 3A/B.

At least one of FIGS. 7A-7C include each of the following dynamic graphical icons: a distance graphics element 791; a right-directional graphics element 792; a left-directional graphics element 793 and a vehicle graphics element 794. The dynamic graphical icons (graphics elements 791, 792, 793 and 794) change characteristics in a manner that conveys information to the driver during the loading process. According to some embodiments, the change in characteristics occurs in substantially real-time in response to movement of the vehicle as tracked by the image processing system 112. FIGS. 7A and 7B also include a graphical text element 795. FIG. 7C includes a stop icon 796.

In general, the state of the graphics display 788 is presented at a first point in time as illustrated in FIG. 7A, at a second point in time subsequent to the first time as illustrated in FIG. 7B and at a third point subsequent in time to the second time as illustrated in FIG. 7C. For purposes of explanation, FIGS. 7A-7C are described with reference to a single vehicle being tracked by the cameras and video processing system 112 on its approach to the loading point on a car wash conveyor. However, a similar approach can be employed for each vehicle entering the car wash.

Referring to FIG. 7A, the vehicle graphics element 794 is illustrated at the bottom of the graphics display 788. This can correspond to the start of the vehicle tracking by the image processing system. At this stage of the vehicle's approach, the distance graphics element 791 has a maximum length to convey a distance between the actual vehicle and the loading point. For example, the distance graphics element 791 as illustrated in FIG. 7B has a reduced length relative to the length of the distance graphics element 791 illustrated in FIG. 7A. According to one embodiment, the change in length of the distance graphics element 791 is proportional to a change in the amount of forward distance traveled by the vehicle between the point in time corresponding to FIG. 7A and the point in time corresponding to FIG. 7B. That is, the distance graphics element 791 can be scaled to a length in the loading area.

As previously indicated, the image processing system 112 can operate to identifying any deviation between the actual travel path of the vehicle and the ideal travel path. According to the illustrated embodiment, the right-directional graphics element 792 and the left-directional graphics element 793 communicate information concerning a direction and magnitude of any correction required by the driver to steer the vehicle onto the loading conveyor. In various embodiments, the information is communicated in a dynamic manner that does not include any numeric information, or in some embodiments, does not include any alpha-numeric information.

FIG. 7A illustrates a situation in which the image processing system 112 detects that the center of the vehicle is currently located to the left of the ideal travel path. As a result, the right-directional graphics element 792 is rendered in a manner that highlights four of the arrows included in the right-directional graphics element. In contrast, FIG. 7B illustrates a situation in which the image processing system 112 detects that the center of the vehicle is currently located to the right of the ideal travel path. As a result, the left-directional graphics element 793 is rendered in a manner that highlights three of the arrows included in the left-directional graphics element.

FIGS. 7A and 7B illustrate a manner in which dynamical graphical icons are employed to convey information concerning a magnitude of the deviation from the ideal travel path. For example, the highlighting of four arrows in FIG. 7A illustrates a greater deviation in the amount that the vehicle is left of the ideal travel path than the highlighting of three arrows in FIG. 7B concerning the amount of deviation to the right of the ideal travel path. Each of FIGS. 7A and 7B also include the graphical text element 795 to provide a written instruction to the driver. According to some embodiments, the graphical text element 795 is not included in the information that is displayed.

FIG. 7C represents a point in time at which the vehicle has reached the loading point, for example, see FIG. 5B. As a result, the vehicle graphics element 794 is located in the top part of the graphics display 788, a stop icon 796 is presented above the vehicle graphics element 794 while the right-directional graphics element 792 and the left-directional graphics element 793 are not displayed.

In further embodiments, the image processing system 112 is employed to detect various accessories that are included in the vehicle that might otherwise be damaged during a standard car washing operation. According to these embodiments, the image processing system 112 identifies an existence of objects such as bike racks, roof racks, back racks and the like that expand an overall profile of the vehicle. An identification of any of these items associated with a vehicle entering the loading area allows the system 100 to modify an operation of the car wash to accommodate the vehicle (including accessories) without damage. For example, the car wash can retract specific brushes based on the video image detection where a standard operation of the brush will otherwise damage the accessory and/or vehicle.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. Mapping pixel-coordinates in a video frame and rendering dynamic graphical icons in a display provide two such examples.

Each computer program within the scope of the claims below may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of assisting a driver to self-load a vehicle on a car wash conveyor using feedback concerning a location of the vehicle relative to an ideal loading path, the feedback displayed to the driver using a graphical display located such that it is visible to the driver while in the vehicle approaching a loading point for the car wash conveyor, the method comprising:
mapping pixel-coordinates in a video frame of an ideal loading path of vehicles at an entrance to the car wash, the ideal loading path corresponding to a path of the vehicles when properly aligned to load the vehicles onto the car wash conveyor;
processing images included in at least one video stream of the entrance to determine whether a vehicle is advancing toward a loading point for the car wash conveyor;
where an approaching vehicle is identified, processing images included in the at least one video stream to determine an amount of an error between an actual location of the approaching vehicle and the ideal loading path, the error determined based at least in part on a lateral alignment of the approaching vehicle relative to the ideal loading path;
where the approaching vehicle is identified, processing images included in the at least one video stream to determine a forward distance the approaching vehicle must travel to reach the loading point; and
displaying a plurality of dynamic graphical icons on the graphical display to illustrate to the driver a first adjustment required to correct for the error and a second adjustment required to drive the approaching vehicle forward to reach the loading point.

2. The method of claim 1, further comprising including at least a first video stream and a second video stream in the at least one video stream,
wherein the first video stream is processed to determine the amount of the error in the lateral alignment of the approaching vehicle relative to the ideal loading path, and
wherein the second video stream is processed to determine the forward distance the approaching vehicle must travel to reach the loading point.

3. The method of claim 1, further comprising including a first dynamic graphical icon in the plurality of graphical icons, the first dynamic graphical icon configured to be displaced in a first direction within the graphical display to represent a forward travel of the approaching vehicle, the forward travel of the approaching vehicle within the display graphically representing a reduced distance between the location of the approaching vehicle and the loading point; and
rendering the first dynamic graphical icon in a manner that conveys a relative distance between the location of the approaching vehicle and the loading point.

4. The method of claim 1, further comprising including a first dynamic graphical icon and a second dynamic graphical icon in the plurality of icons,
wherein the first dynamic graphical icon is configured to display a first non-numeric symbol representative of a magnitude of an adjustment in a first direction required by the driver to position the approaching vehicle on the ideal loading path, and
wherein the second dynamic graphical icon is configured to display a second non-numeric symbol representative of a magnitude of an adjustment in a second direction required by the driver to position the approaching vehicle on the ideal loading path, the second direction opposite the first direction.

5. The method of claim 1, wherein the ideal loading path corresponds to a central loading path of the approaching vehicle, the method further comprising:
processing the images in the video stream using edge detection to identify a location of the approaching vehicle;
comparing a central location of the approaching vehicle with the ideal loading path to determine the error;
determining a magnitude of any lateral misalignment between the location of the approaching vehicle relative to the ideal loading path; and
displaying a non-numeric symbol representative of a magnitude of an adjustment required by the driver to position the approaching vehicle on the ideal loading path, the non-numeric symbol scaled to illustrate a relative magnitude of the adjustment.

6. The method of claim 1, further comprising:
employing at least one camera to capture the at least one video stream;
processing the video stream using an image processing system; and
calibrating the image processing system such that a set of pixels that define the ideal loading path are oriented based on an orientation of the at least one camera relative to the car wash conveyor in each video frame.

7. A non-transitory computer-readable medium comprising computer program instructions executable by at least one computer processor to perform a method of providing assistance to allow a driver to self-load a vehicle on a car wash conveyor using feedback concerning a location of the vehicle relative to an ideal loading path, the feedback displayed to the driver using a graphical display located such that it is visible to the driver while in the vehicle approaching a loading point for the car wash conveyor, the method comprising:
mapping pixel coordinates in a video frame of an ideal loading path of vehicles at an entrance to the car wash, the ideal loading path corresponding to a path of the vehicles when properly aligned to load the vehicles onto the car wash conveyor;
processing images included in at least one video stream of the entrance to determine whether a vehicle is advancing toward a loading point for the car wash conveyor;
where an approaching vehicle is identified, processing images included in the at least one video stream to determine an amount of an error between an actual location of the approaching vehicle and the ideal loading path, the error determined as a lateral alignment of the approaching vehicle relative to the ideal loading path;
where the approaching vehicle is identified, evaluating images included in the at least one video stream to determine a forward distance the approaching vehicle must travel to reach the loading point; and
displaying a plurality of dynamic graphical icons on the graphical display to illustrate to the driver a first adjustment required to correct for the error and a second adjustment required to drive the approaching vehicle forward to reach the loading point.

8. The non-transitory computer readable medium of claim 7, the method further comprising including at least a first video stream and a second video stream in the at least one video stream,
wherein the first video stream is processed to determine the amount of the error in the lateral alignment of the approaching vehicle relative to the ideal loading path, and
wherein the second video stream is processed to determine the forward distance the approaching vehicle must travel to reach the loading point.

9. The non-transitory computer readable medium of claim 7, the method further comprising:
including a first dynamic graphical icon in the plurality of graphical icons, the first dynamic graphical icon configured to be displaced in a first direction within the graphical display to represent a forward travel of the approaching vehicle, the forward travel of the approaching vehicle within the display graphically representing a reduced distance between the location of the approaching vehicle and the loading point; and
rendering the first dynamic graphical icon in a manner that conveys a relative distance between the location of the approaching vehicle and the loading point.

10. The non-transitory computer readable medium of claim 7, the method further comprising including a first dynamic graphical icon and a second dynamic graphical icon in the plurality of icons,
wherein the first dynamic graphical icon is configured to display a first non-numeric symbol representative of a magnitude of an adjustment in a first direction required by the driver to position the approaching vehicle on the ideal loading path, and
wherein the second dynamic graphical icon is configured to display a second non-numeric symbol representative of a magnitude of an adjustment in a second direction required by the driver to position the approaching vehicle on the ideal loading path, the second direction opposite the first direction.

11. The non-transitory computer readable medium of claim 7, wherein the ideal loading path corresponds to a central loading path of the approaching vehicle, the method further comprising:
processing the images in the video stream using edge detection to identify a location of the approaching vehicle;
comparing a central location of the approaching vehicle with the ideal loading path to determine the error;
determining a magnitude of any lateral misalignment between the location of the approaching vehicle relative to the ideal loading path; and
displaying a non-numeric symbol representative of a magnitude of an adjustment required by the driver to position the approaching vehicle on the ideal loading path, the non-numeric symbol scaled to illustrate a relative magnitude of the adjustment.

12. The non-transitory computer readable medium of claim 7, the method further comprising:
employing at least one camera to capture the at least one video stream;
processing the video stream using an image processing system; and
calibrating the image processing system such that a set of pixels that define the ideal loading path are oriented based on an orientation of the at least one camera relative to the car wash conveyor.

13. A system configured to assist a driver in self-loading a vehicle on a car wash conveyor at a loading point located at an entrance to the car wash conveyor, the system comprising:
at least one camera configured to capture a video stream including a plurality of video frames each including images of the loading point;
an image processing system configured to map pixel-coordinates in video frames of an ideal loading path of vehicles at the entrance to the car wash conveyor and where an approaching vehicle is identified, process images included in the video stream to determine an amount of an error between an actual location of the approaching vehicle and the ideal loading path, the error determined based at least in part on a lateral alignment of the approaching vehicle relative to the ideal loading path, the ideal loading path corresponding to a path of the approaching vehicle when properly aligned to load the approaching vehicle onto the car wash conveyor; and
a display configured to display a plurality of dynamic graphical icons on the graphical display to illustrate to the driver a first adjustment required to correct for the error.

14. The system of claim 13, wherein where the approaching vehicle is identified, evaluating images included in the at least one video stream to determine a forward distance the approaching vehicle must travel to reach the loading point, and
wherein the display is configured to display an additional dynamic graphical icon included in the plurality of graphical icons to illustrate to the driver a second adjustment required to drive the approaching vehicle forward to reach the loading point.

15. The system of claim 14, wherein the at least one camera includes a plurality of cameras including a first camera configured to capture a first video stream and a second camera configured to capture a second video stream.

16. The system of claim 15, wherein the first video stream is processed to determine the amount of the error in the lateral alignment of the approaching vehicle relative to the ideal loading path, and
wherein the second video stream is processed to determine a forward distance the approaching vehicle must travel to reach the loading point.

17. The system of claim 13, wherein the plurality of dynamic graphical icons include a first dynamic graphical icon and a second dynamic graphical icon,
wherein the first dynamic graphical icon is configured to display a first non-numeric symbol representative of a magnitude of an adjustment in a first direction required by the driver to position the approaching vehicle on the ideal loading path, and
wherein the second dynamic graphical icon is configured to display a second non-numeric symbol representative of a magnitude of an adjustment in a second direction required by the driver to position the approaching vehicle on the ideal loading path, the second direction opposite the first direction.

18. The system of claim 13, wherein the plurality of dynamic graphical icons include a first dynamic graphical icon in the plurality of graphical icons, the first dynamic graphical icon configured to be displaced in a first direction within the graphical display to represent a forward travel of the approaching vehicle, the forward travel of the approaching vehicle within the display graphically representing a reduced distance between the location of the approaching vehicle and the loading point, and
wherein the display is configured to render the first dynamic graphical icon in a manner that conveys a relative distance between the location of the approaching vehicle and the loading point.

19. The system of claim 13, wherein the ideal loading path corresponds to a central loading path of the approaching vehicle,
wherein the image processing system is configured to process the images in the video stream using edge detection to identify a location of the approaching vehicle, to compare a central location of the approaching vehicle with the ideal loading path to determine the error and determine a magnitude of any lateral misalignment between the location of the approaching vehicle relative to the ideal loading path, and
wherein the display is configured to display a non-numeric symbol representative of a magnitude of an adjustment required by the driver to position the approaching vehicle on the ideal loading path, the non-numeric symbol scaled to illustrate a relative magnitude of the adjustment.
